(19) United States
(12) Patent Application Publication
(10) Pub. No.: US 2013/0297326 A1
(43) Pub. Date: Nov. 7, 2013

(54) Set of Novel Algorithms and Processes for Mortgage and Investment Innovations

(71) Applicant: Gewei Ye, Timonium, MD (US)

(72) Inventor: Gewei Ye, Timonium, MD (US)

(21) Appl. No.: 13/464,968

(22) Filed: May 5, 2012

(51) Int. Cl. G06Q 40/06; G06Q 50/22; G06Q 40/02

(52) U.S. Cl. 705/2; 705/38

(57) ABSTRACT

The invention set proposes net gains formulas for an alternative to mortgage defaults (i.e., mortgage to rent programs) to prevent foreclosures, attempting to save global economy from another crisis. The set also provides novel formulas to calculate the default probability for mortgage of a home located by a mobile GPS.

The set includes processes, models, algorithms and strategies related to sentiment analysis shown in Ye's 2011 Wiley book “High-Frequency Trading Models”. It contains original software design flowchart to use near real-time stock or brand tweets from twitter, news and text analytics to conduct sentiment analysis for stocks and brands.

The set offers a novel framework and algorithms to assess fund managers' decision styles. It also provides two actionable approaches to price healthcare claims reasonably to reduce costs, and to price and create claims-backed stock and derivatives markets for U.S. government to pay for large healthcare bills.

### 1. BACKGROUND

1.1 Field of the Invention

The present inventions relate to technology and process advancement in mortgage and investment industry. They include a set of novel financial algorithms and processes to (1) calculate the net gains for bankers and homeowners should they choose to use mortgage to rent approach to solve foreclosure challenges; (2) to compute default probabilities for mortgages; (3) to transform portfolio management with sentiment analysis that provides quality and actionable behavioral trading strategies; (4) to assess the persistent behavioral attributes (i.e., the decision styles) of fund managers, including decision bias, sensitivity to opportunities, and performance in a ROC (receiver operating characteristic) space with the novel Analytical Behavioral Computing approach; (5) to price health services reasonably for national healthcare cost reduction, and to price and sell new special purpose entity stocks and derivatives backed by federal claims payment streams, as to generate very large new revenue for tax payers and U.S. government to pay for the increasing healthcare bills.

1.2 Description of the Related Art

### 1.2.1 Mortgage to Rent Algorithms

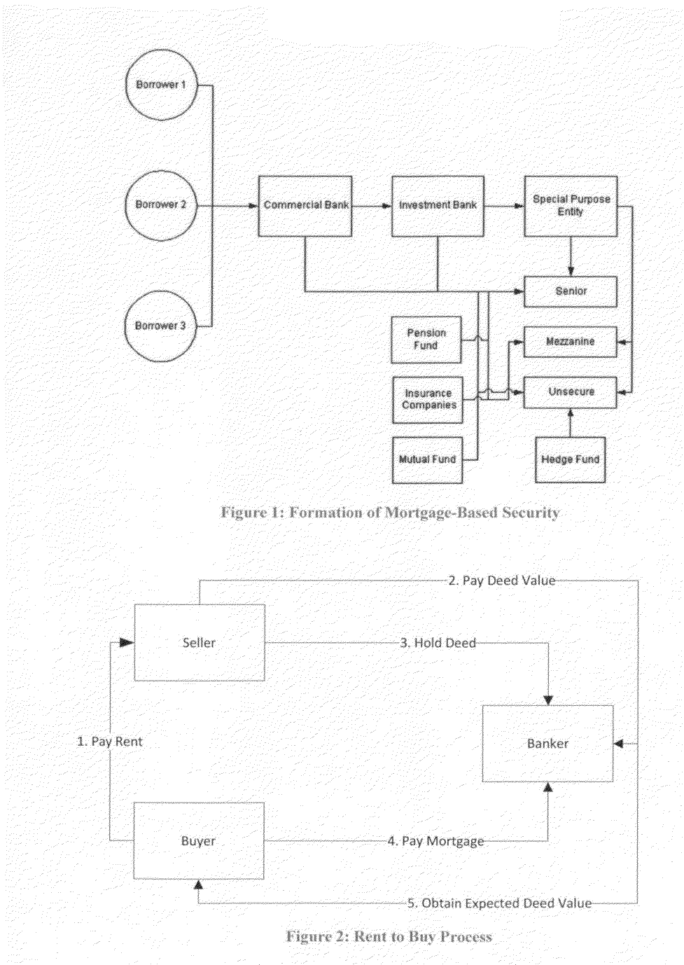

Mortgage foreclosures or home loan defaults triggered the 2008 epic financial crisis as they stopped the monthly income to the special purchase entity (SPE) of mortgage-based security (see FIG. 1). In order to solve the foreclosure challenges, novel financial instruments are created including the “mortgage to rent” pilot program by Bank of America (see Timiraos, Wall Street Journal, 2012, Mar. 23).

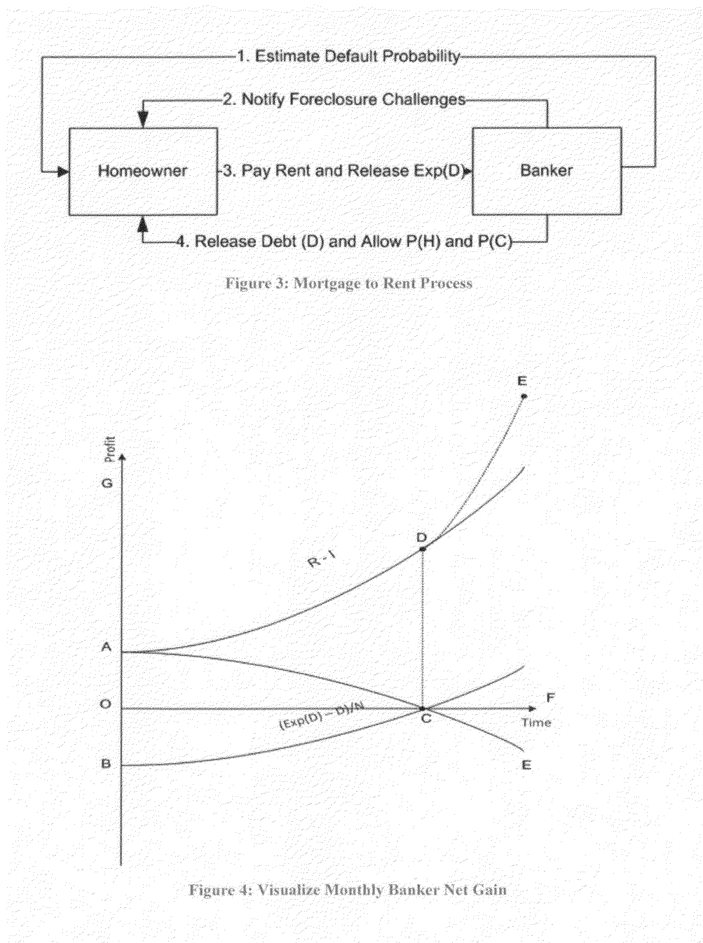

In the “mortgage to rent” pilot program by Bank of America, “homeowners agree to sign over ownership of the property to the banker. In exchange, former homeowners are offered one-year leases with options to renew the leases in each of the following two years at rents that the bank determines are at or below the current market price.” (See Timiraos, Wall Street Journal, 2012, Mar. 23). See FIG. 2 for the “Buy to Rent” process and FIG. 3 for the “Mortgage to Rent” process.

However, there is not yet a sound economic analysis (e.g., net gain calculations) of bankers and homeowners for the “mortgage to rent” programs. If the quantitative financial benefits are unclear to bankers and homeowners, then there would be no proper understanding and execution of the programs that affect the balance sheets of the banks. This could give rise to the failure of the wide adoption of the program in mortgage industry. As a result, the attempt to fix the economy with the foreclosure alternative (i.e., the mortgage to rent programs) may not succeed.

### 1.2.2. Geo Mortgage Algorithms

Although the Merton option model and Moody's KMV analytics estimate the default risk premium for risky loans (Merton 1974, Saunders 2008, Hull 2008), little has been done in literature and practice to create novel mortgage default formulas for homes that may be located by GPS with mobile devices.

### 1.2.3 Investment Algorithms for Sentiment Analysis

With the advent of behavioral finance and investor psychology (Kahneman and Tversky, 1979, 2000; Thaler, 1.991, 1999; Van Raaij, 1984; Ye, 2005; Shiller, 2000; Barberis, Shleifer, and Vishny, 1998; Barberis and Xiong, 2009), more and more people realize that investor sentiment (confidence) plays a crucial role in asset pricing. Yet one lacks sound real-time measures of investor sentiment for an individual asset that matters in the asset's price movement.

Sentiment asset pricing engine (SAPE) is a unique set of computer algorithms that are built on top of modern portfolio theory (MPT; Markovitz, 1952), capital asset pricing model (CAPM; Sharpe, 1964; French, 2003), and especially the Black-Scholes option pricing model (1973), by adding a human factor in asset pricing, namely, traders' real-time sentiment. Though the traditional models have considered important elements like risk and return, future option pricing, and volatility clustering, traders' sentiment can also affect stock prices. As the traditional models did not consider human factors, SAPE fills the gap by adding traders' sentiments into the equation. SAPE estimates future prices of individual assets by aggregating traders' real-time sentiments. It provides evidence-based and actionable recommendations for practical investment decisions.

The TopTickEngine, built with the SAPE algorithms, is designed to transform portfolio management with quality and actionable behavioral trading strategies.

Text analytics uses computer programs to analyze the sentiment, meaning and other content of text information in order to derive insights for better decision making and choice.

### 1.2.4 Analytical Behavioral Computing to Assess Fund Managers

A (mutual/hedge) fund's past performance (e.g., in Sharpe ratio, Ye 2011, pp204) may not predict its future performance due to market volatility. For example, some funds generally outperforming market indexes under-performed the market largely in 2011 (empirical reference).

Yet the attributes of a fund manager's decision style may be persistent and stable over time. We create a novel approach with algorithms to assess the persistent behavioral attributes (i.e., the decision styles) of fund managers, including decision bias, sensitivity to opportunities, and performance in a ROC (receiver operating characteristic) space.

As the behavioral attributes of fund managers will be analyzed quantitatively and market volatility (risk) is thus controlled, this novel approach is labeled as the analytical behavioral computing (ABC) approach for risk management and fund performance (asset) management. ABC entails a conceptual framework and a set of analytical algorithms. ABC will be part of the behavioral finance literature and practice that incorporate analytical behavioral computing approaches to asset management.

1.2.5 Generate New Revenue and Reduce National Healthcare Payment through Improvements

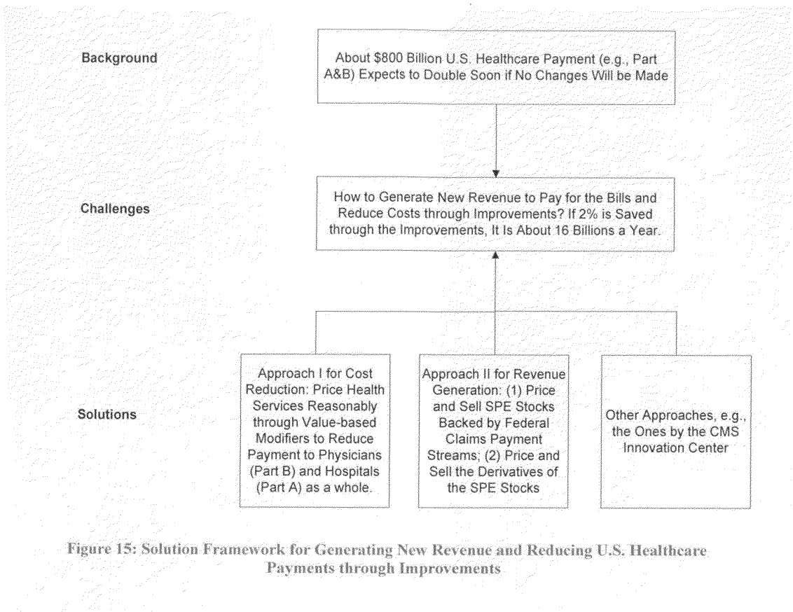

United States spends about $800 billion a year on healthcare payments through Medicare and Medicaid programs, accounting for about 20% of the annual overall federal budget. It is expected that the total healthcare payment will double soon if no changes are made (FIG. 15).

How to generate new revenue and reduce costs through improvements? I propose two actionable methods: (1) price health services reasonably, and (2) price and sell new stocks and new derivatives derived from the claim payment streams.

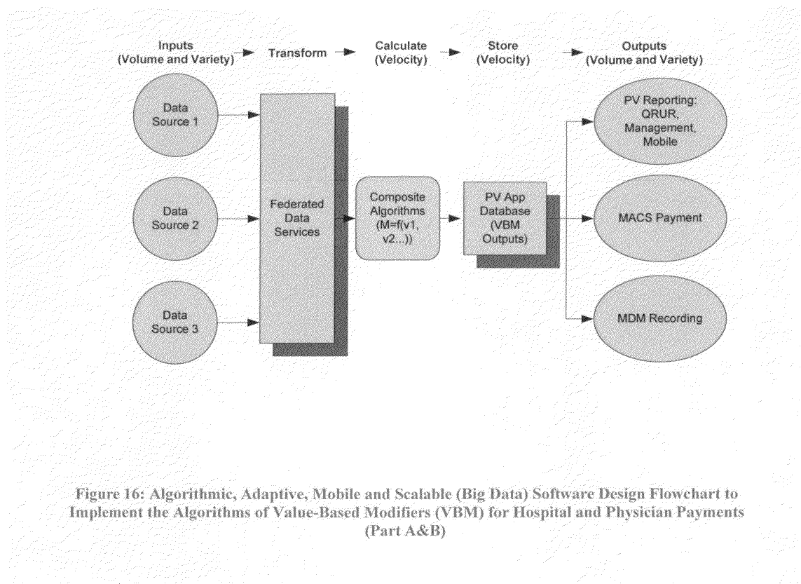

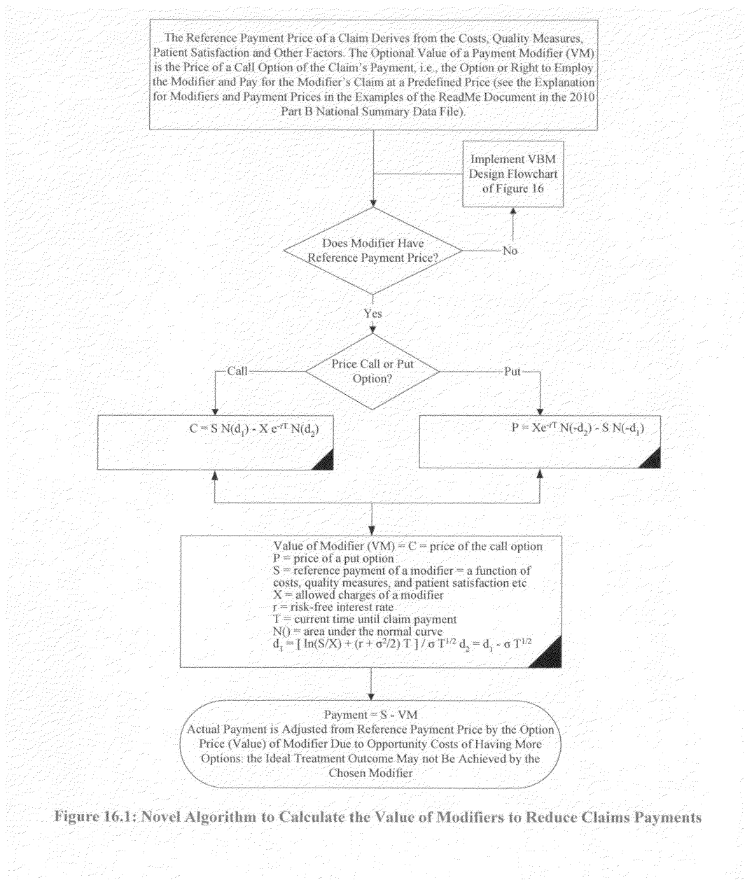

For the first method, I develop a Big Data software design flowchart (FIG. 16) to compute the prices of value-based modifiers for large amount of physician and hospital claims for Medicare and Medicaid payments. The design covers Big Data solutions to address data volume, data velocity and data variety. For example, the very large volume of Part B claims requesting payments is estimated to be 2.47 billion in 2011, predicted to double within 5 years, constituting a Big Data challenge for the federal government to process the data volume.

If 2% of the claims payments can be reduced through the value-based modifiers materialized from the design flowchart (FIG. 16) and the composite algorithms (FIG. 16.1), then it will attempt to generate up to $16 billion savings a year for U.S. government and tax payers. The algorithms to compute the financial value of the modifiers are documented in FIG. 16.1, which is also applicable to the practices of health insurance companies.

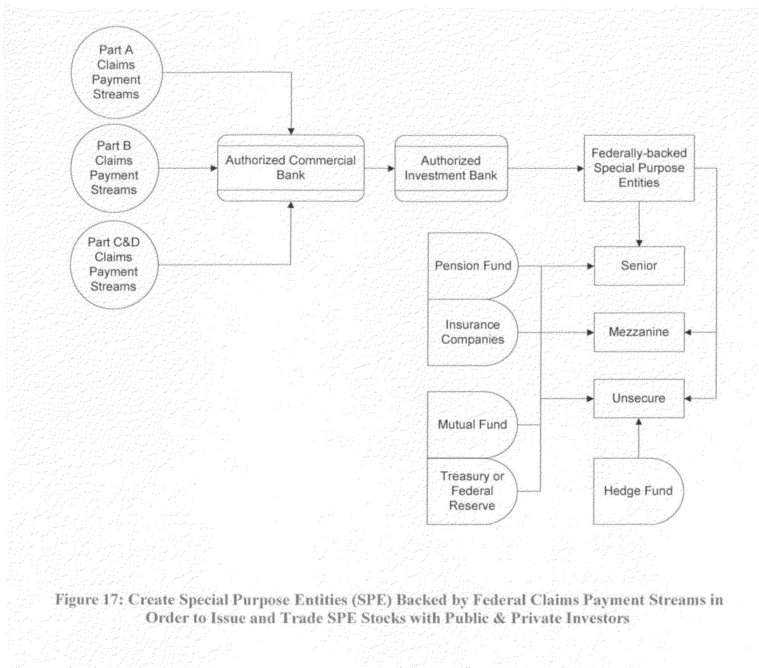

For the second method, I propose for the federal government and federally-authorized banks to create a new financial market for public and private investors to purchase stocks of new special purpose entities (SPEs) backed by the claim payment streams (FIG. 17). The government or the banks will then create and price derivatives (e.g., options) of the SPE stocks for investors to hedge the risk of payment price fluctuation of the claims. Hence, the second new financial market will be created as the derivatives market based on the SPE stocks.

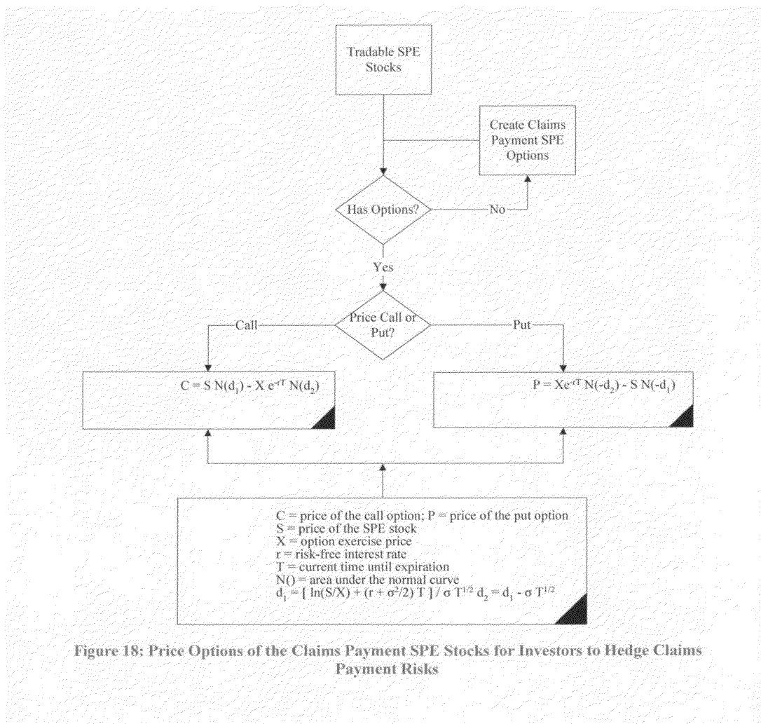

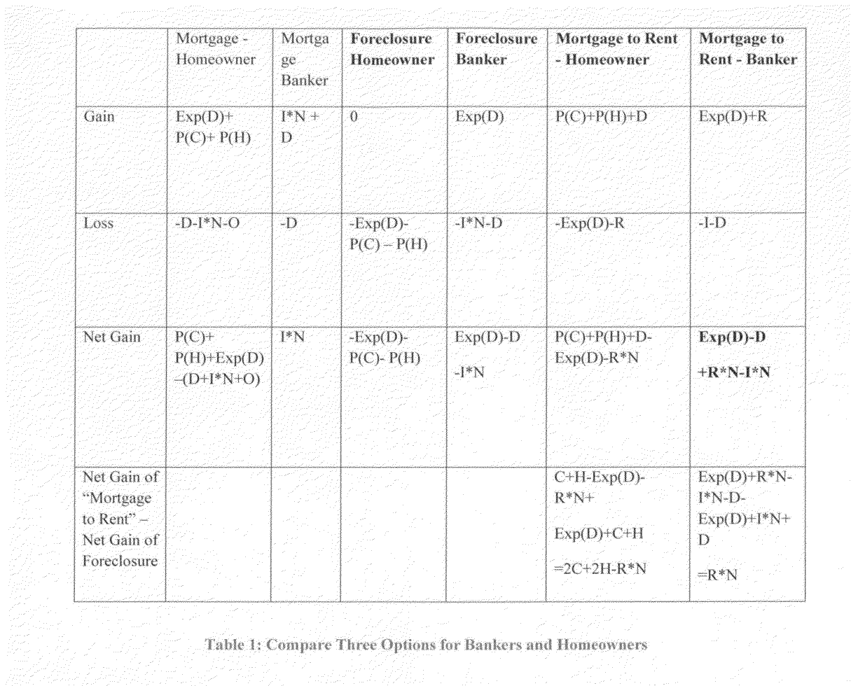

As a result, U.S. government and tax payers will have the opportunity to attempt to collect very large amount of funds by selling two types of novel financial instruments, i.e., the stocks of the SPEs backed by Part A&B claims, and the derivatives of the SPE stocks. These funds are estimated to be up to half the size of the annual national healthcare payment (e.g., $400 billion a year). The new revenue will be used to pay for the increasing national healthcare bills. The options of the SPE stocks will be priced based on the Black Scholes formula that will be applied to the novel financial healthcare security instrument (FIG. 18).

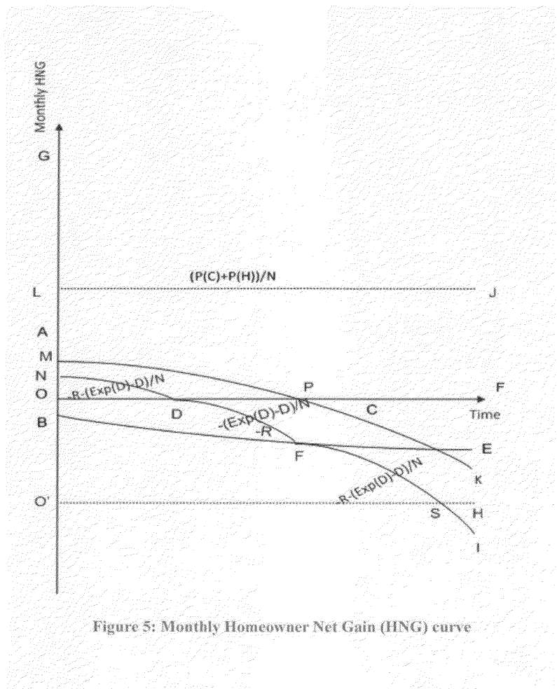

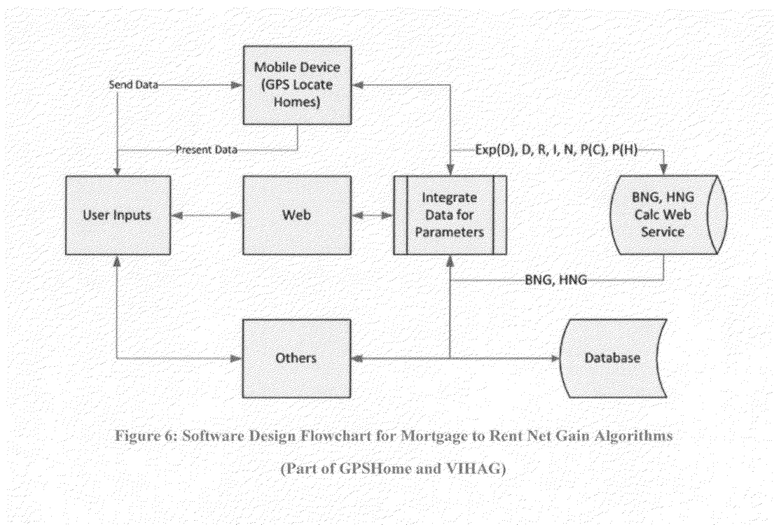

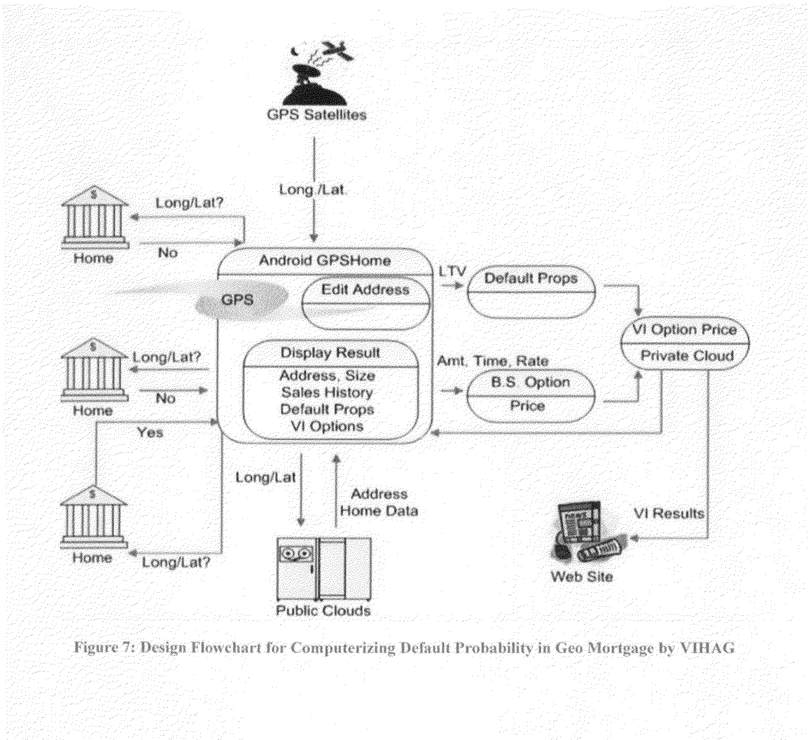

1. What I claim as my inventions are novel algorithms for mortgage related innovations including:
The novel algorithm to calculate the net gains for bankers (FIG. 4 and Table 1) should they choose to use mortgage to rent approach to solve foreclosure challenges.
The novel algorithm to calculate the net gains for homeowners (FIG. 5 and Table 1) should they choose to use mortgage to rent approach to solve foreclosure challenges.
The novel software design flowchart (FIG. 6) that describes the “Mortgage to Rent” process with default probability that may be used to build a SOA based software (i.e., GPSHome for VIHAG) to calculate the net gains for bankers and homeowners with the mortgage to rent algorithms.
The novel algorithm to calculate the default probability (FIG. 7) for a mortgage for a home that may be located by the GPS of a mobile device (i.e., GPSHome for VIHAG).

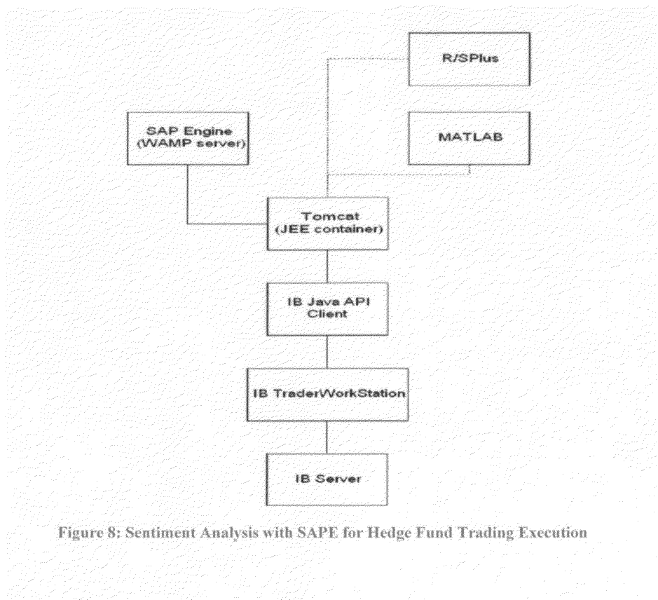

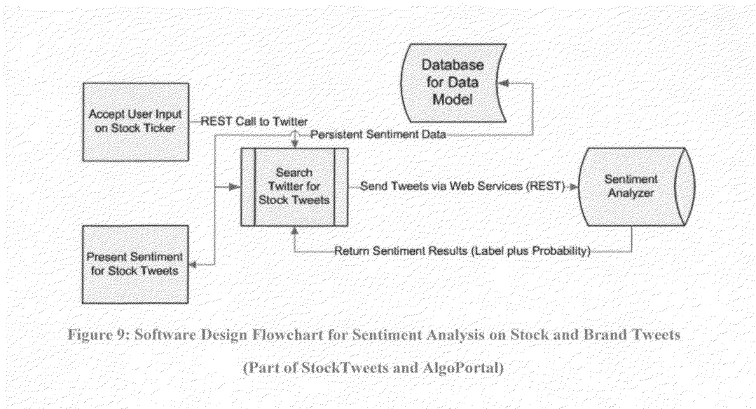

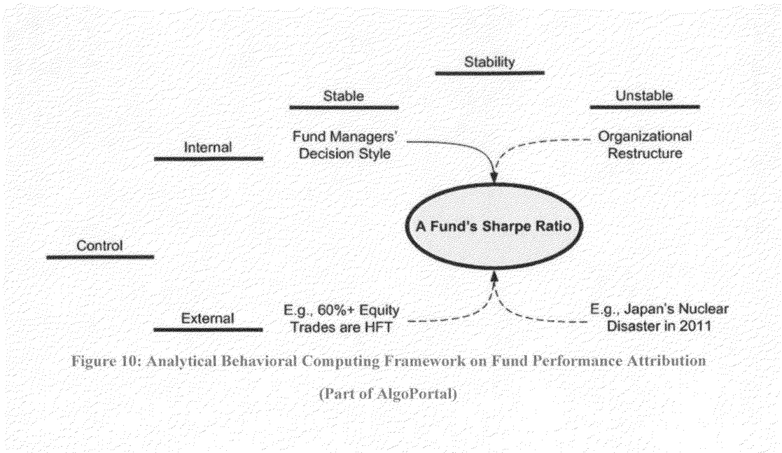

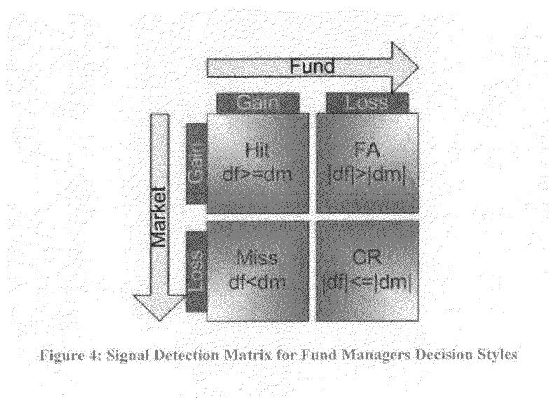

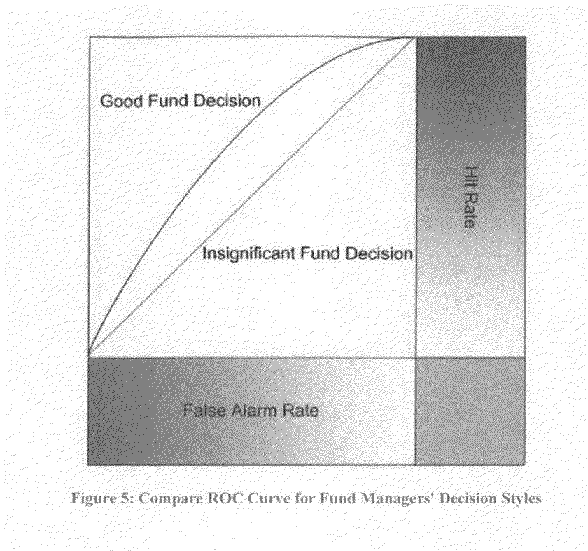

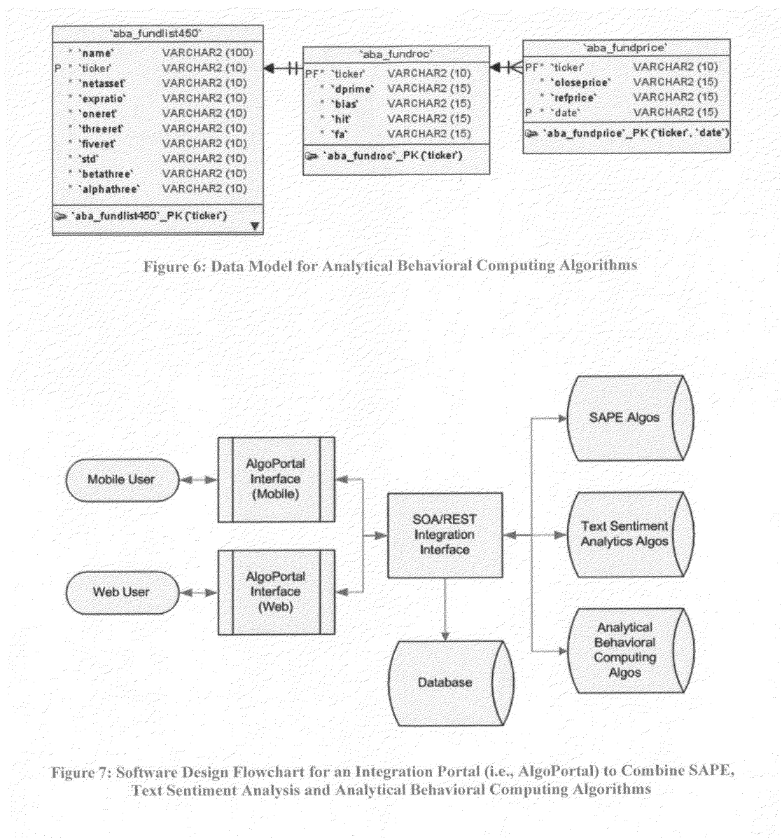

2. What I claim as my inventions are novel algorithms for investment related innovations including:
The novel algorithms to compute the sentiment-based asset prices for equities and funds, and the software artifacts that employ the algorithms (e.g., AlgoPortal for mobile devices).
The novel processes, models, software design flowchart (FIG. 8), formulas, strategies and other artifacts related to sentiment analysis demonstrated as SAPE and TopTickEngine that are documented in Ye's 2011 book “High-Frequency Trading Models” by John Wiley & Sons, Inc. The claim also includes the novel algorithms to discover loss aversion in option pricing as documented in Ye, 2011 (pp 61-64), and the novel approach to compute risk propensity as an alternative to Value at Risk as documented in Ye, 2011 (pp147-149) and http://yeswici.com/wordpress/riskanalytics
The novel process and REST-based software design flowchart (FIG. 9) and software artifacts (e.g., StockTweets and AlgoPortal for mobile devices) that use near real-time stock or brand tweets from twitter, news and/or text analytics to conduct sentiment analysis for stocks and brands.
The novel framework, algorithms, software design flowchart and prototypes (e.g., AlgoPortal for mobile devices), data models, reports, processes and other artifacts (FIGS. 10, 11, 12 and 13) of the Analytical Behavioral Computing approach for fund performance management through assessing fund managers' decision styles.
The novel software design flowchart for an integration portal (e.g., AlgoPortal) on mobile devices to deliver services enabled by SAPE, Text Sentiment Analysis and Analytical Behavioral Computing Algorithms (FIG. 14).
The novel Big Data software design flowchart (FIG. 16) and algorithms (FIG. 16.1) to compute composite algorithms for value-based modifiers, as to price Part A & B claims reasonably for federal claims payments to reduce national healthcare costs through improvements.
The novel approach and process to create stocks of special purpose entities backed by Part A & B claims payment streams. This attempts to generate large amount of revenue for U.S. government to pay for the increasing healthcare bills (FIG. 17).
The novel approach, algorithms and process to price options of the SPE stocks (FIG. 18) backed by federal Part A&B claims payment. This attempts to generate new revenue for Federal government to pay for the increasing healthcare bills.
